(19) United States
(12) Patent Application Publication
(10) Pub. No.: US 2023/0231513 A1
(43) Pub. Date: Jul. 20, 2023

(54) SOLAR PANEL ASSEMBLY

(71) Applicant: Saint-Augustin Canada Electric Inc., Saint-Augustin-De-Desmaures (CA)

(72) Inventor: Maxime Roberge, Sainte-Catherine-de-la-Jacques-Cartier (CA)

(21) Appl. No.: 18/008,570

(22) PCT Filed: Jun. 11, 2021
(86) PCT No.: PCT/IB2021/055180

§ 371 Date: Dec. 6, 2022

Related U.S. Application Data
(60) Provisional application No. 63/037,622, filed on Jun. 11, 2020.

(51) Int. Cl. H02S 30/10

(52) U.S. Cl. CPC H02S 30/10; H02S 20/23

(57) ABSTRACT

A support structure for solar panels including a frame having a base plate for abutment on a receiving surface, the base plate extending laterally between a first lateral end and a second lateral end; a first supporting plate projecting from the base plate at the first lateral end thereof; a second supporting plate projecting from the base plate at the second lateral end thereof; a first hook-shaped body secured to the first supporting plate for supporting at least one first solar panel; and a second hook-shaped body secured to the second supporting plate for supporting at least one second solar panel.

### TECHNICAL FIELD

The present invention relates to the field of solar energy generators, and more particularly to solar panel assemblies.

### BACKGROUND

Solar cells are electrical devices that convert the energy of light directly into electricity by the photovoltaic effect. A photovoltaic (PV) module is a packaged connected assembly of photovoltaic solar cells part of a photovoltaic system which generates and supplies solar electricity for commercial and residential applications.

Photovoltaic mounting systems (also called solar module racking) are used to fix solar panels on surfaces like roofs, building facades, or the ground. These mounting systems generally enable retrofitting of solar panels on roofs or as part of the structure of the buildings.

Photovoltaic mounting systems generally comprise a plurality of parts that need to be assembled in specific ways which depends on the manufacturer of the mounting systems. Adding extra features such as sun deflectors, cable and ballast trays require installation time and additional tools. Further, alignment of such structures may be burdensome as to ensure straight arrays, measurement and markings must be done prior to assembly. Some mounting systems can only be used with one type of ballast and a ground cable is needed to connect every structure between each other.

Therefore, there is a need for an improved solar panel assembly.

### SUMMARY

One or more embodiments of the present technology have been developed based on inventors’ appreciation that there is a need for a support structure for solar panels that can be manufactured easily, comprises a low number of parts that need to be assembled, and that can be easily installed without requiring specialized tools and accommodate a broad range of solar panels structures.

In accordance with a broad aspect, there is provided a support structure for solar panels comprising: a frame comprising: a base plate for abutment on a receiving surface, the base plate extending laterally between a first lateral end and a second lateral end; a first supporting plate projecting from the base plate at the first lateral end thereof; a second supporting plate projecting from the base plate at the second lateral end thereof; a first hook-shaped body secured to the first supporting plate for supporting at least one first solar panel; and a second hook-shaped body secured to the second supporting plate for supporting at least one second solar panel.

In one embodiment, the first hook-shaped body comprises a third supporting plate projecting outwardly from the first supporting plate and at least one tongue projecting inwardly from the third supporting plate for holding the at least one first solar panel.

In one embodiment, the at least one first solar panels comprises two first solar panels and the at least one tongue comprises a first tongue extending along a first given section of a length of the third supporting plate for holding a given one of the two first solar panels and a second tongue extending along a second given section of the length of the third supporting plate for holding another of the two first solar panels, the first and second tongue being longitudinally spaced apart.

In one embodiment, the third supporting plate extends longitudinally between a first longitudinal end and a second longitudinal end, the first tongue being adjacent the first longitudinal end and the second tongue being adjacent the second longitudinal end.

In one embodiment, the at least one tongue further comprises a spacer tongue projecting inwardly from the third supporting plate and being positioned between the first and second tongues, the spacer tongue being longitudinally spaced apart from the first and second tongues by a given distance.

In one embodiment, the given distance is chosen based on a thickness of a frame of the first solar panels.

In one embodiment, the given substance is equal to the thickness of the frame.

In one embodiment, the second hook-shaped body comprises a third supporting plate projecting outwardly from the second supporting plate and at least one tongue projecting inwardly from the third supporting plate for holding the at least one first solar panel.

In one embodiment, the at least one second solar panels comprises two first solar panels and the at least one tongue comprises a first tongue extending along a first given section of a length of the third supporting plate for holding a given one of the two second solar panels and a second tongue extending along a second given section of the length of the third supporting plate for holding another of the two second solar panels, the first and second tongue being longitudinally spaced apart.

In one embodiment, the third supporting plate extends longitudinally between a first longitudinal end and a second longitudinal end, the first tongue being adjacent the first longitudinal end and the second tongue being adjacent the second longitudinal end.

In one embodiment, the at least one tongue further comprises a spacer tongue projecting inwardly from the third supporting plate and being positioned between the first and second tongues, the spacer tongue being longitudinally spaced apart from the first and second tongues by a given distance.

In one embodiment, the given distance is chosen based on a thickness of a frame of the first solar panels.

In one embodiment, the given substance is equal to the thickness of the frame.

In one embodiment, the first hook-shaped body comprises a third supporting plate projecting outwardly from the first supporting plate and at least one first tongue projecting inwardly from the third supporting plate for holding the at least one first solar panel, and the second hook-shaped body comprises a fourth supporting plate projecting outwardly from the second supporting plate and at least one second tongue projecting inwardly from the fourth supporting plate for holding the at least one second solar panel.

In one embodiment, the support structure further comprises a central arm extending between a first arm portion and a second arm portion, the frame being further provided with a first aperture extending partially in the first supporting plate and partially in the third supporting plate and a second aperture extending partially in the second supporting plate and partially in the fourth supporting plate, the first aperture for receiving therein the first arm portion and the second aperture for receiving therein the second arm portion.

In one embodiment, the first arm portion is provided with at least one first push tab projecting from a lateral face thereof and the second arm portion is provided with at least one second push tab projecting from a lateral face thereof for removably securing the central arm to the frame.

In one embodiment, the first arm portion is provided with at least one first connection tab projecting from a lateral face thereof for securing the first arm portion to at least one the at least one first solar panel, and the second arm portion is provided with at least one second connection tab projecting from a lateral face thereof for securing the second arm portion to at least one the at least one second solar panel.

In one embodiment, the at least one first tongue comprises two first lateral tongues and a first central tongue and the at least one second tongue comprises two second lateral tongues and a second central tongue, the first central tongue being spaced apart from the two first lateral tongues and positioned between the two first lateral tongues, the second central tongue being spaced apart from the two second lateral tongues and positioned between the two second lateral tongues, the first central tongue facing the first aperture and the second central tongue facing the second aperture.

In one embodiment, the support structure further comprises at least one lateral arm extending between a first arm section and a second arm section, the frame being further provided with at least one first lateral aperture extending partially in the first supporting plate and partially in the third supporting plate, and at least one second lateral aperture extending partially in the second supporting plate and partially in the fourth supporting plate, the first arm section being insertable into the at least one first lateral apertures and the second arm section being insertable into the at least one second lateral aperture for removably securing the at least one lateral arm to the frame.

In one embodiment, the first arm section is provided with at least one first push tab projecting from a lateral face thereof and the second arm section is provided with at least one second push tab projecting from a lateral face thereof for removably securing the central arm to the frame.

In one embodiment, a width of the first supporting plate and a width of the second supporting plate are chosen at least based on a desired orientation for the at least one first solar panel and the at least one second solar panel.

In one embodiment, the width of the first supporting plate is larger than the width of the second supporting plate.

In one embodiment, an angle between the first supporting plate and the base plate is greater than 90 degrees.

In one embodiment, an angle between the second supporting plate and the base plate is greater than 90 degrees.

### BRIEF DESCRIPTION OF THE DRAWINGS

Further features and advantages of the present invention will become apparent from the following detailed description, taken in combination with the appended drawings, in which:

FIG. 1 is a perspective view of a solar panel array comprising a plurality of solar panels mounted to a plurality of support structures, in accordance with one or more non-limiting embodiments of the present technology;

FIG. 2 is a perspective view of one of the support structures of FIG. 1, the support structure comprising a plate assembly, a central arm and two lateral arms, in accordance with one or more non-limiting embodiments of the present technology;

FIG. 3 is a top view of the support structure of FIG. 2;

FIG. 4 is a bottom view of the support structure of FIG. 2;

FIG. 5 is a front perspective view of the plate assembly of the support structure of FIG. 2;

FIG. 6 is a rear perspective view of the plate assembly of the support structure of FIG. 2;

FIG. 7 is a side view of the plate assembly of FIG. 2 having a lateral arm mounted thereto, in accordance with an embodiment;

FIG. 8a is a perspective view of the lateral arm of the support structure of FIG. 2, in accordance with an embodiment;

FIG. 8b is a side view taken of the lateral arm of FIG. 8a;

FIG. 9a is a top perspective view of the central arm of the support structure of FIG. 2, in accordance with an embodiment;

FIG. 9b is a side view taken of the central arm of FIG. 9a;

FIG. 9c is a bottom perspective view of the central arm of FIG. 9a;

FIG. 10 is a close-up perspective view illustrating a top portion of the central arm of FIG. 9a partially inserted into the support structure of FIG. 2;

FIG. 11 is a close-up perspective view illustrating a bottom portion of the central arm of FIG. 9a partially inserted into the support structure of FIG. 2;

FIG. 12 illustrates a bottom perspective view the solar panel of FIG. 1, in accordance with one or more non-limiting embodiments of the present technology;

FIG. 13 is a close-up perspective view illustrating a top portion of the central arm of FIG. 9a mounted the support structure of FIG. 2 and mounted to the solar panel of FIG. 12; and

FIG. 14 is a close-up perspective view illustrating a bottom portion of the central arm of FIG. 9a mounted to the support structure of FIG. 2 and two solar panels.

It will be noted that throughout the appended drawings, like features are identified by like reference numerals.

### DETAILED DESCRIPTION

In accordance with one or more embodiments of the present technology, there is provided a support structure for solar panels which is easy to manufacture and/or assemble and/or does not require specialized tools or skills for installation. The support structure of the present technology enables mounting and connecting solar panels together, and may be used as a ballast tray and/or a wind deflector. The support structure may accommodate different solar panel structures and may be manufactured to accommodate different orientations for the solar panels relative to the surface on which they are installed. In one embodiment, self-tapping grounding screws may be used with the support structure for grounding needs. In one embodiment, the use present support structure does not require the installation of any additional securing means on the receiving surface on which the support structure is to be received. Furthermore, the support structure allows for preserving the integrity and/or the watertightness of the receiving surface, such as the roof of a building, since no holes need to be made in the receiving surface.

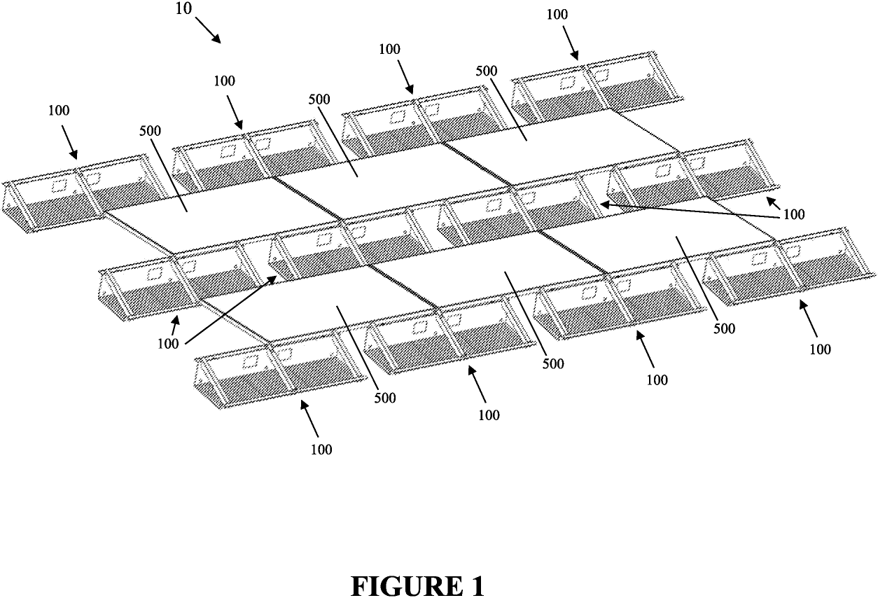

FIG. 1 illustrates one embodiment of a solar panel array 10 which comprises a plurality of solar panels 500 mounted to a plurality of support structures 100. More precisely, the exemplary solar panel array 10 comprises twelve support structures 100 and six solar panels 500. The support structures 100 are organized as three rows each comprising four support structures 100 positioned side-by-side along a longitudinal axis. In the illustrated embodiment, the longitudinal axes along which the support structures 100 are aligned in each row are parallel together. In the illustrated embodiment, the solar panels are also organized as two rows of solar panels each comprising three solar panels 500. Within each row, the solar panels are positioned side-by-side along a longitudinal axis and the longitudinal axes along which the panels 500 are aligned in each row are parallel together.

Within each row of support structures 100, two adjacent support structures 100 are spaced apart by a first or longitudinal distance and two adjacent rows of support structures 100 are spaced apart by a second or lateral distance. The person skilled in the art will understands that the first and second distances are chosen based on the dimensions of the solar panels 500.

The person skilled in the art will appreciate that a first end of the solar panel 500 is mounted to a higher portion of two adjacent support structures 100 contained in a same first row of support structures 100, and the opposite end of the solar panel 500 is mounted to the lower portion of two adjacent support structures 100 contained in a second row of support structures 100 that is adjacent to the first row of support structures 100, thereby inclining the solar panel 500 towards a preferred orientation. The person skilled in the art will appreciate that the preferred orientation is orthogonal to the surface of the solar panel 500. In one embodiment, the preferred orientation is chosen so as to maximize the electrical output and may depend on the terrestrial latitude where the solar panel array 10 is installed. For example, the preferred orientation may be chosen to maximize the amount of incident direct light received on the solar panels 500 during the daytime. The person skilled in the art will understand that the preferred orientation for the solar panels 500 may be achieved by adequately choosing the dimensions of the support structures 100.

A support structure 100 is configured to have at least one solar panel 500 mounted thereto. As illustrated in FIG. 1, the support structures 100 located at each extremity of each row of support structures 100 each have only one solar panel 500 mounted thereto, the support structures 100 of the top row and the bottom row other than the most right and the most left support structures 100 each have two solar panels 500 mounted thereto, and the two central support structures 100, i.e. the second and third support structures 100 of the middle row of support structures 100, each have four solar panels 500 mounted thereto.

In the context of the present technology, a solar panel assembly refers to a combination of a support structure 100 and one or more solar panel 500. In one embodiment, a solar panel 500 is mounted on four different support structures 100, i.e., each corner of a solar panel 500 is mounted to a respective support structures. In the illustrated embodiment, the two top corners of a solar panel 500 are mounted to two adjacent support structures 100 of a same given row of support structures 100, and the two bottom corners of the solar panel 500 are mounted to two adjacent support structures of another row of support structures 100, the other row of support structures 100 being adjacent to the given row of support structures 100.

It should be understood that the number of support structures 100 and the number of solar panels 500 are exemplary and may vary as long as the array 10 comprises at least one solar panel 500 and four support structures 100.

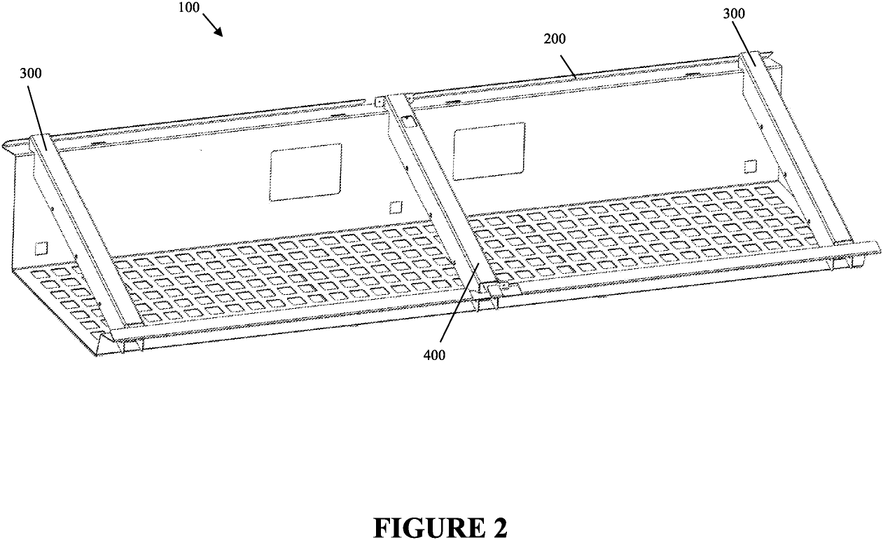

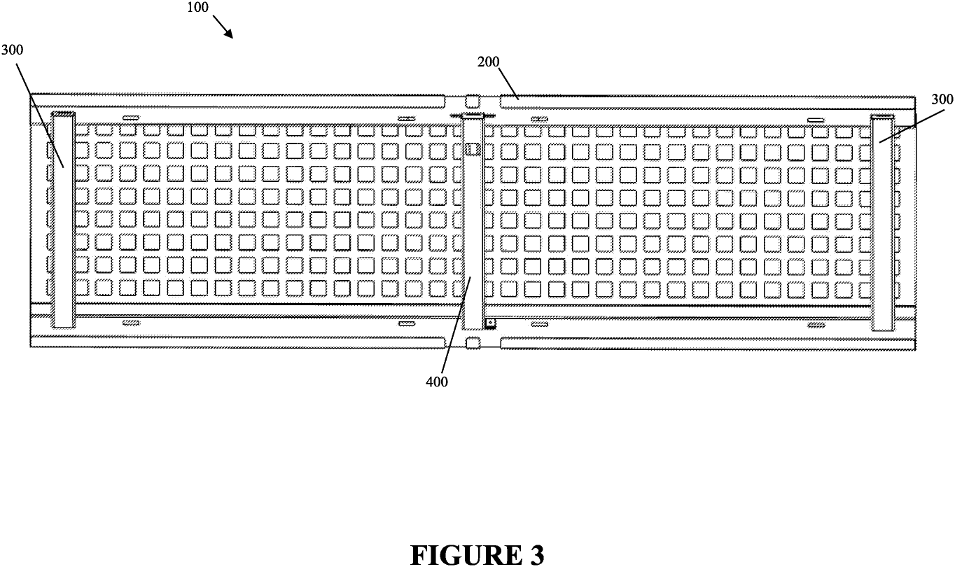

With reference to FIG. 2 to FIG. 4, a non-limiting embodiment of a support structure 100 is depicted. Generally, a support structure 100 comprises a plate assembly or frame 200, two side or lateral supporting arms 300 and a central supporting arm 400. Each supporting arm 300, 440 is transversally securable to the frame 200, as described in greater detail below. The person skilled in the art will understand that the side support arms 300 and the central support arm 400 are securable to the plate assembly 200 to provide structural support thereto so that the shape of the frame 200 does not substantially change when solar panels are secured thereto. In one embodiment, the side supporting arms 300 and the central supporting arm 400 are removably securable to the plate assembly 200 by a releasably attachable means, thereby facilitating the assembling and the disassembling of the solar panel assembly.

A solar panel 500 is secured to a support structure 100 by a coupling means. In one embodiment and as described above, the support structure 100 comprises a first or top hook-shaped body for coupling to at least one first solar panel 500 and a second or bottom hook-shaped body for coupling to at least one second solar panel 500. In one embodiment, a solar panel 500 can be fixedly secured to a support structure 100 by means of a grounding screw or the like.

In one or more embodiments, the central supporting arm 400 is positioned at equal distance between the two side supporting arms 300. It will be appreciated that the distances between the central supporting arm 400 and the two side supporting arms 300 may vary.

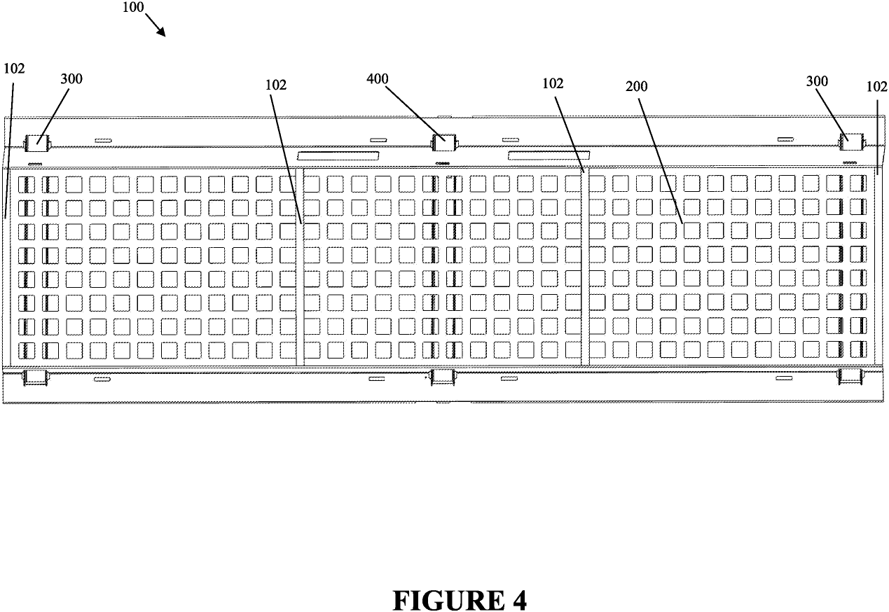

In one embodiment and as illustrated in FIG. 4, at least one slip-resistant strip 102, such as a rubber strip, may be secured beneath the support structure 100. In an exemplary embodiment, the support structure 100 comprises four slip resistant strips 102 to improve the adherence of the support structure 100 on the surface on which the support structure 100 is positioned.

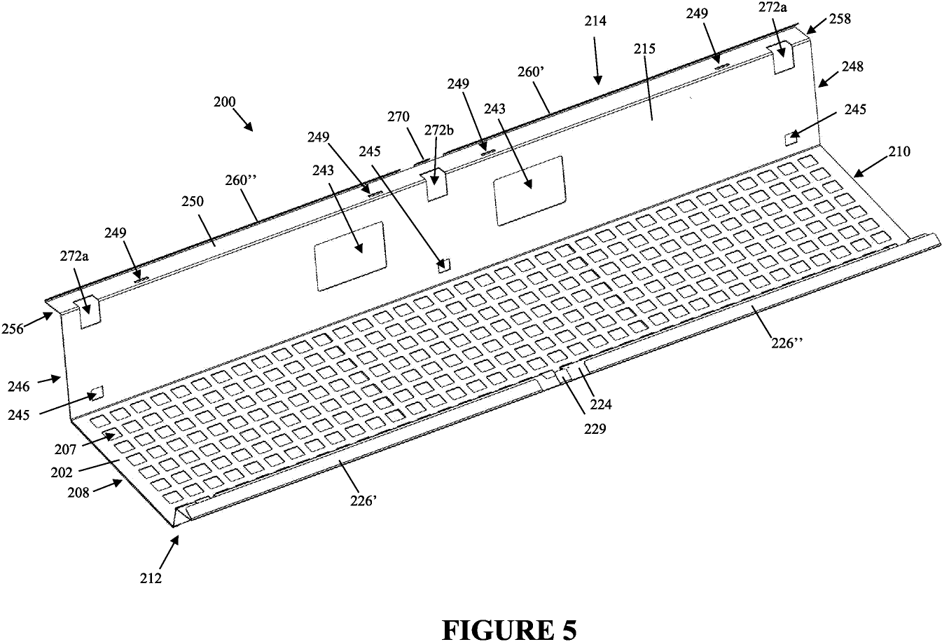

FIGS. 5 to 7 illustrate a non-limiting embodiment of a plate assembly or frame 200.

The plate assembly 200 of the support structure 100 includes, inter alia, a base plate 202 having a first or bottom face 203 for abutting a receiving surface and a second or top face 205 opposite to the first face. The base plate 202 extends laterally between a first lateral end 204 and a second lateral end 206, and longitudinally between a first longitudinal end 208 and a second longitudinal end 210.

In one embodiment, the first face 203 of the base plate 202 is sized and shaped to abut a ground. It will be appreciated that the ground may be any adequate surface configured for receiving the solar panel assembly, such a floor, a roof of a structure such as a building, or another surface over which a solar panel assembly may be disposed over. It is contemplated that in one or more embodiments of the present technology, a heavy object such as a brick or a sandbag may be positioned on the second face 205 of the base plate 202 to further secure the support structure 100 against the ground. In this case, the present support structure 100 does not require the installation of any additional securing means on the surface on which the support structure 100 is to be received. Furthermore, the present support structure 100 allows for preserving the integrity and/or the watertightness of the receiving surface on which the support structure 100 is received, such as the roof of a building, since no holes need to be made in the receiving surface.

In one or more alternative embodiments, the base plate 202 may be secured to the ground via other means such as but not limited to fasteners.

A first panel supporting body 212 is secured at the first lateral end 204 of the base plate 202, and a second panel supporting body 214 is secured at the second lateral end 206 of the base plate 202. In the following, the space comprised between the second surface 205 of the base plate 202 and the first and second supporting bodies 212 and 214 is referred to as the internal space of the frame 200. The first panel supporting body 212 projects outwardly (i.e., away from the internal space of the frame 200) and upwardly (i.e. away from the second face 205 of the base plate 202) from the base plate 202. The second panel supporting body 214 projects outwardly and upwardly from the base plate 202.

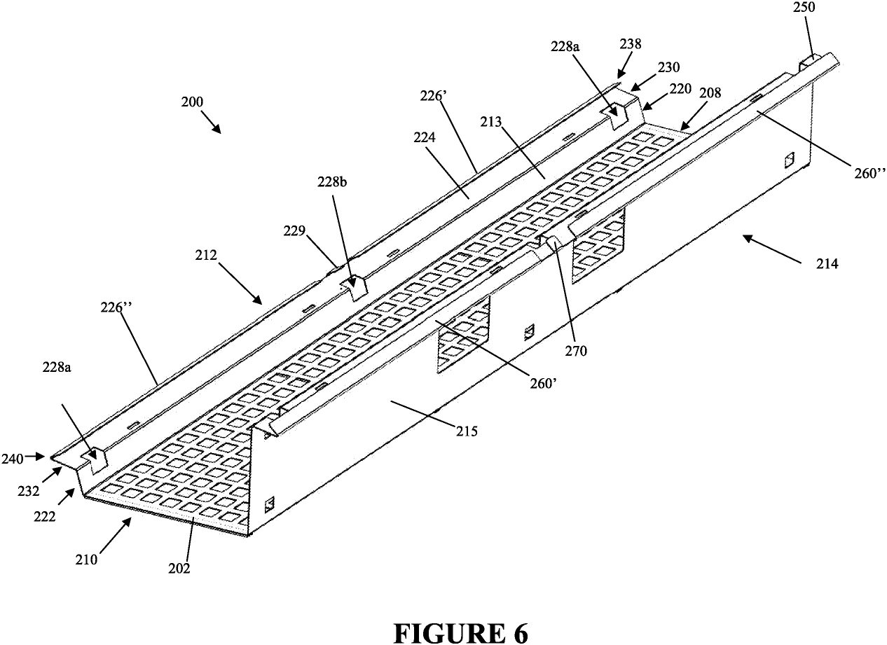

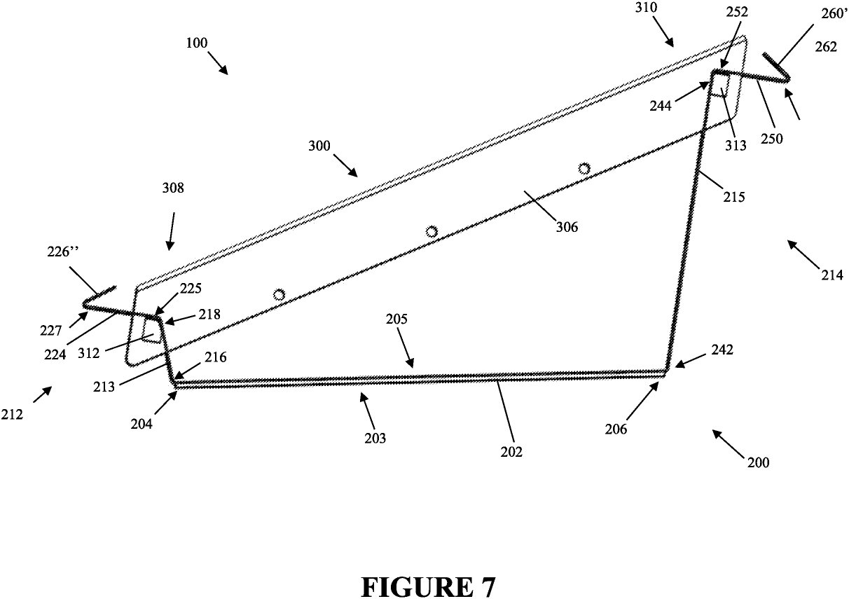

As best seen in FIGS. 6 and 7, the first panel supporting body 212 comprises a first supporting plate 213, a second supporting plate 224 and three tongues 226′, 226″ and 229.

The first supporting plate 213 extends laterally between a first end 216 secured to the first lateral end 204 of the base plate 202 and a second end 218. The first supporting plate 213 further extends longitudinally between a first end 220 and a second end 222. The first supporting plate 213 extends upwardly and outwardly from the base plate 202 at the end 204 thereof.

The first panel supporting body 212 further comprises a second supporting plate 224 which extends laterally between a first end 225 secured to the first supporting plate 213 and a second end 227, and longitudinally between opposite longitudinal ends 230 and 232. The second supporting plate 224 projects upwardly and outwardly from the first supporting plate 213 at the end 218 thereof.

The first panel supporting body 212 also comprises two lateral or side tongues 226′ and 226″ and a central tongue 229 which form together a tongue body which projects upwardly and inwardly (i.e., in direction of the internal space) from the second supporting plate 224. The first lateral tongue 226′ projects upwardly and inwardly from the end 227 of the second supporting plate 224 and extends longitudinally along a given portion of the length of the second supporting plate 224 from the end 232 of the second supporting plate 224. The second lateral tongue 226″ projects upwardly and inwardly from the end 227 of the second supporting plate 224 and extends longitudinally along a given portion of the length of the second supporting plate 224 from the end 230 of the second supporting plate 224. The central tongue 229 projects upwardly and inwardly from the end 227 of the second supporting plate 224, extends longitudinally along a given portion of the length of the second supporting plate 224 and is positioned at the center of the length of the second supporting plate 224. The central tongue 229 is longitudinally spaced apart from the first lateral tongue 226′ by a first space and from the second lateral tongue 226″ by a second space. The length of the first and second spaces is chosen so as to be at least equal to the thickness of the frame of a solar panel 500 so that the frame of a solar panel 500 can be positioned between the first lateral tongue 226′ and the central tongue 229 and between the second lateral tongue 226″ and the central tongue 229. The central tongue 229 acts as a spacer for spacing two adjacent solar panels when coupled to a same support structure 100 and the length of the central tongue 229 is chosen based the length of a desired space between two adjacent solar panels.

The person skilled in the art will appreciate that the second supporting plate 224 and the first tongue 226′ form together a hook-shaped body on which a solar panel can be abutted. The first hook-shaped body then supports and maintains in position the solar panel 500. When a solar panel 500 is coupled with the first hook-shaped body of the first panel supporting body 212, the bottom side of the frame of a solar panel 500 abuts the second supporting plate 224 and the tongue 226′ prevents the solar panel from moving outwardly. Similarly, the second supporting plate 224 and the second lateral tongue 226″ form together a second hook-shaped body on which a solar panel can be abutted. The second hook-shaped body then supports and maintains in position the solar panel 500. When a solar panel 500 is coupled with the second hook-shaped body of the first panel supporting body 212, the bottom side of the frame of a solar panel 500 abuts the second supporting plate 224 and the second lateral tongue 226″ prevents the solar panel from moving outwardly.

As best seen in FIG. 6, the first panel supporting body 212 comprises three apertures each sized and shaped for receiving a respective arm 300, 440 therein. The three apertures comprise two lateral apertures 228a each for receiving a respective lateral supporting arm 300, and a central aperture 228b, for receiving therein the central supporting arm 400. Each lateral aperture 228a is located at the intersection of the first and second supporting plates 213 and 224 each adjacent to a respective longitudinal end of the frame 200. Each lateral aperture 228a extends partially within the first supporting plate 213 and partially within the second supporting plate 224. The portion of the lateral aperture 228a within the first supporting plate 213 has a rectangular shape. Similarly the portion of the lateral aperture 228a within the second supporting plate 224 has also a rectangular shape. The central aperture 228b is centered along the length of the frame 200 and is located at the intersection of the first and second supporting plates 213 and 224. The central aperture 228b extends partially within the first supporting plate 213 and partially within the second supporting plate 224. The portion of the central aperture 228b within the first supporting plate 213 has a rectangular shape. Similarly the portion of the central aperture 228b within the second supporting plate 224 has also a rectangular shape. It will be understood that the shape and size of the aperture 228a, 228b is chosen as a function of the shape and size of the portion of the supporting arm 300, 400 to be received therein.

As best seen in FIGS. 5 and 7, the second panel supporting body 214 comprises a first supporting plate 215, a second supporting plate 250 and three tongues 260′, 260″ and 270.

The first supporting plate 215 extends laterally between a first end 242 secured to the second lateral end 206 of the base plate 202 and a second end 244. The first supporting plate 215 further extends longitudinally between a first end 246 and a second end 248. The first supporting plate 215 extends upwardly and outwardly from the base plate 202 at the end 206 thereof.

The second panel supporting body 214 further comprises a second supporting plate 250 which extends laterally between a first end 252 secured to the first supporting plate 215 and a second end 254, and longitudinally between opposite longitudinal ends 256 and 258. The second supporting plate 250 projects upwardly and outwardly from the first supporting plate 215 at the end 244 thereof.

The second panel supporting body 214 also comprises two lateral or side tongues 260′ and 260″ and a central tongue 270 which form together a tongue body which projects upwardly and inwardly from the second supporting plate 250. The first lateral tongue 260′ projects upwardly and inwardly from the end 254 of the second supporting plate 250 and extends longitudinally along a given portion of the length of the second supporting plate 250 from the end 258 thereof. The second lateral tongue 260″ projects upwardly and inwardly from the end 254 of the second supporting plate 250 and extends longitudinally along a given portion of the length of the second supporting plate 250 from the end 256 thereof. The central tongue 270 projects upwardly and inwardly from the end 254 of the second supporting plate 250, extends longitudinally along a given portion of the length of the second supporting plate 250 and is positioned at the center of the length of the second supporting plate 250. The central tongue 270 is longitudinally spaced apart from the first lateral tongue 260′ by a first space and from the second lateral tongue 260″ by a second space. The length of the first and second spaces is chosen so as to be at least equal to the thickness of the frame of a solar panel 500 so that the frame of a solar panel 500 can be positioned between the first lateral tongue 260′ and the central tongue 270 and between the second lateral tongue 260″ and the central tongue 270. The central tongue 270 acts as a spacer for spacing two adjacent solar panels when coupled to a same support structure 100 and the length of the central tongue 270 is chosen based the length of a desired space between two adjacent solar panels.

The person skilled in the art will appreciate that the second supporting plate 250 and the first tongue 260′ form together a hook-shaped body on which a solar panel can be abutted. The first hook-shaped body then supports and maintains in position the solar panel 500. When a solar panel 500 is coupled with the first hook-shaped body of the second panel supporting body 214, the bottom side of the frame of a solar panel 500 abuts the second supporting plate 250 and the tongue 260′ prevents the solar panel from moving outwardly. Similarly, the second supporting plate 250 and the second lateral tongue 260″ form together a second hook-shaped body on which a solar panel can be abutted. The second hook-shaped body then supports and maintains in position the solar panel 500. When a solar panel 500 is coupled with the second hook-shaped body of the second panel supporting body 214, the bottom side of the frame of a solar panel 500 abuts the second supporting plate 250 and the second lateral tongue 260″ prevents the solar panel from moving outwardly.

As best seen in FIG. 5, the second panel supporting body 214 comprises three apertures each sized and shaped for receiving a respective arm 300, 440 therein. The three apertures comprise two lateral apertures 272a each for receiving a respective lateral supporting arm 300, and a central aperture 272b, for receiving therein the central supporting arm 400. Each lateral aperture 272a is located at the intersection of the first and second supporting plates 215 and 250 each adjacent to a respective longitudinal end of the frame 200. Each lateral aperture 272a extends partially within the first supporting plate 215 and partially within the second supporting plate 250. The portion of the lateral aperture 272a within the first supporting plate 215 has a rectangular shape. Similarly the portion of the lateral aperture 272a within the second supporting plate 250 has also a rectangular shape. The central aperture 272b is centered along the length of the frame 200 and is located at the intersection of the first and second supporting plates 215 and 250. The central aperture 272b extends partially within the first supporting plate 215 and partially within the second supporting plate 250. The portion of the central aperture 272b within the first supporting plate 215 has a rectangular shape. Similarly the portion of the central aperture 272b within the second supporting plate 250 has also a rectangular shape. It will be understood that the shape and size of the aperture 272a, 272b is chosen as a function of the shape and size of the portion of the supporting arm 300, 400 to be received therein.

As illustrated in FIG. 7, the width of the supporting plate 213, i.e., the distance between the ends 216 and 218 of the supporting plate 213, is shorter than the width of the supporting plate 215, i.e. the distance between the ends 242 and 244 of the supporting plate 215. It will be understood that the difference between the width of the supporting plate 213 and the width of the supporting plate 215 is chosen at least partially based on the desired orientation for the solar panel(s) to be mounted on the support structure 100.

While in the illustrated embodiment the width of the supporting plate 224 is substantially equal to that of the supporting plate 250 and the width of the tongues 226′, 226″ and 229 is substantially equate to that of the tongues 260′, 260″ and 270, it should be understood that other configurations may be possible.

While in the illustrated embodiment, the angle between the base plate 202 and the supporting plate 213 and the angle between the base plate 202 and the supporting plate 215 are greater than 90 degrees, it should be understood that other angle values may be possible. For example, the angle between the base plate 202 and the supporting plate 213 and/or the angle between the base plate 202 and the supporting plate 215 may be equal to 90 degrees.

Similarly, while the angle between the supporting plate 213 and the supporting plate 224 is greater than 90 degrees and the angle between the supporting plate 215 and the supporting plate 250 is about 90 degrees, other configurations may be possible.

In a preferred embodiment, the angle between the supporting plate 224 and the tongues 226′, 226″ and 229 and the angle between the supporting plate 250 and the tongues 260′, 260″ and 270 are less than 90 degrees.

In one embodiment, the second supporting plate 215 comprises two holes 243 and three holes 245, and the supporting plate 250 is provided with four holes 249. The holes 243 and 249 may designed for allowing the insertion of electrical cables therethrough for example. In another example, holes 243 and 249 may designed for receiving fasteners for holding electrical cables. In an example, the holes 245 may be designed for receiving therethrough posts to be used for delineating a safety perimeter.

In one embodiment, the frame 200 is made of different plates that are secured together. For example, the different plates may be welded together. In another embodiment, the frame 200 is integral. In this case, the frame 200 may be molded. In another example, the frame 200 may be made of a single plate which may be folded, machined, cut out, bored, and/or the like. In one embodiment, the frame 200 is made of metal such as aluminum.

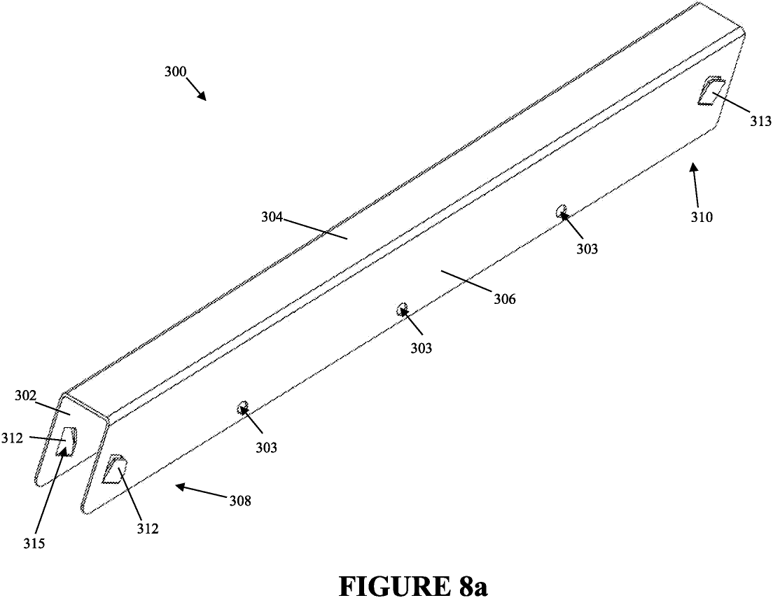

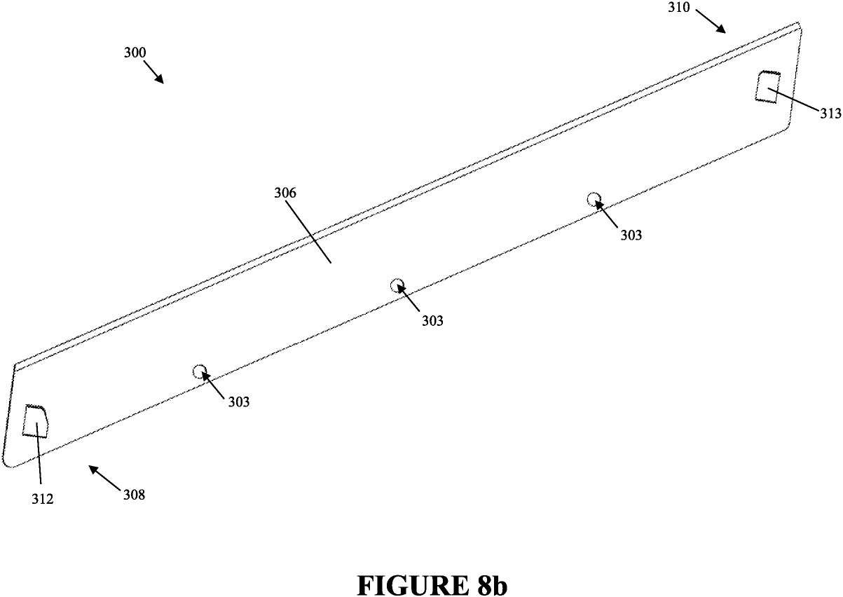

FIG. 8a and FIG. 8b illustrate a non-limiting embodiment of a lateral support arm 300. The lateral supporting arm 300 is provided with a U-shaped cross-sectional shape and comprises a first longitudinal face 302, a top face 304 and a second longitudinal face 306. It is contemplated that the lateral support arm 300 may have a different shape.

The side supporting arm 300 extends longitudinally between a first end portion 308 and a second end portion 310. The first end portion 308 is sized and shaped so as to be insertable into an opening 228a of the frame 200 and the second end portion 310 is sized and shaped so as to be insertable into an opening 272a of the frame 200 for securing the lateral supporting arm 300 to the frame 200. The first end portion 308 is provided with an outwardly bevelled shape and the second end portion 310 is provided with an inwardly bevelled shape.

The first end portion 308 of the side supporting arm 300 is provided with two push tabs 312 each located on a respective longitudinal face 302, 306. Each push tab 312 projects outwardly from its respective longitudinal face 302, 306 in direction of the top face 304 of the side supporting arm 300. In the illustrated embodiment, the two push tabs 312 are identical and each have the shape of a rectangle provided with a truncated corner. It should be understood that while being rigid, each push tab 312 is flexible and can be pushed towards its respective longitudinal face 302, 306. Each longitudinal face 302, 306 is provided with an aperture 315 that faces a respective push tab 312. Each aperture 315 is sized and shaped so as to allow the insertion of its respective push tab 312 therein. In the illustrated embodiment, the shape and size of the aperture 315 match those of the push tab 312. In order to secure the arm 300 to the frame 200, the first end portion 308 is inserted into an opening 228a of the frame 200 and a force is exerted on the first end portion 308, which pushes the tabs 312 into their respective apertures 315 hereby allowing a complete insertion of the first end portion 308 into the opening 228a. Once the first end portion 308 is completely inserted into the opening 228a and the push tabs 312 have crossed the opening 228a, the push tabs 312 return to their initial position, thereby removably securing the first end portion 308 to the frame 200. The first end portion 308 may be disengaged from the frame 200 by pushing the push tabs 312 towards their respective aperture 315 and pulling the supporting arm 300 away from the frame 200.

Similarly, the second end portion 310 of the side supporting arm 300 is provided with two push tabs 313 each located on a respective longitudinal face 302, 306. Each push tab 313 projects outwardly from its respective longitudinal face 302, 306 in direction of the top face 304 of the side supporting arm 300. In the illustrated embodiment, the two push tabs 313 are identical and each have the shape of a rectangle. It should be understood that while being rigid, each push tab 313 is flexible and can be pushed towards its respective longitudinal face 302, 306. Each longitudinal face 302, 306 is provided with an aperture (not shown) that faces a respective push tab 313. Each aperture is sized and shaped as to allow the insertion of its respective push tab 313 therein. In the illustrated embodiment, the shape and size of the aperture match those of the push tab 313. In order to secure the arm 300 to the frame 200, the second end portion 310 is inserted into an opening 272a of the frame 200 and a force is exerted on the second end portion 310, which pushes the tab 313 into their respective aperture, thereby allowing a complete insertion of the second end portion 310 into the opening 272a. Once the second end portion 310 is completely inserted into the opening 272a and the push tabs 313 have crossed the opening 272a, the push tabs 312 return to their initial position thereby removably securing the second end portion 310 to the frame 200. The second end portion 310 may be disengaged from the frame 200 by pushing the push tabs 313 towards their respective aperture and pulling the supporting arm 300 away from the frame 200.

In one embodiment, the first and second faces 302 and 306 are provided with holes 303 for allowing the insertion of cables therethrough for example.

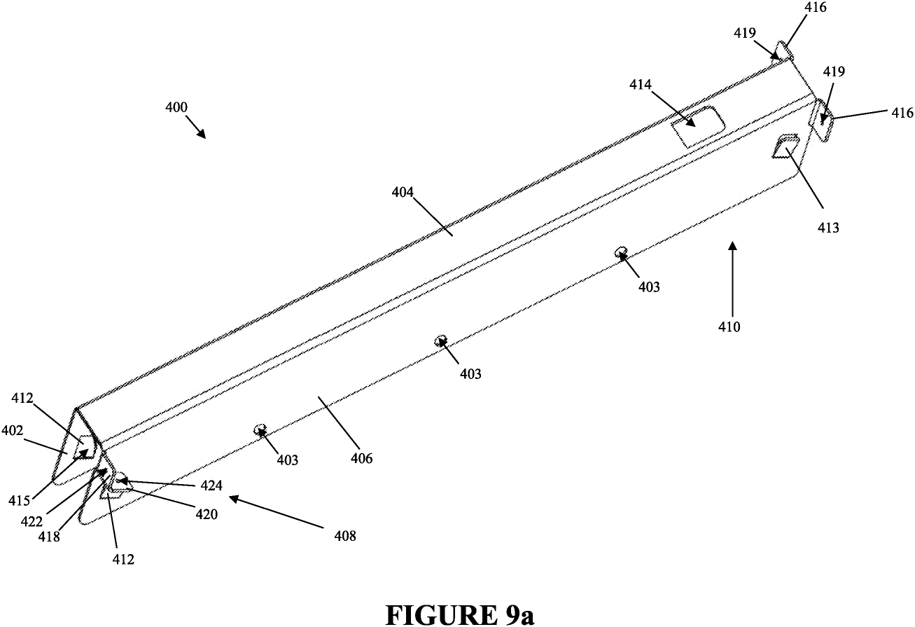

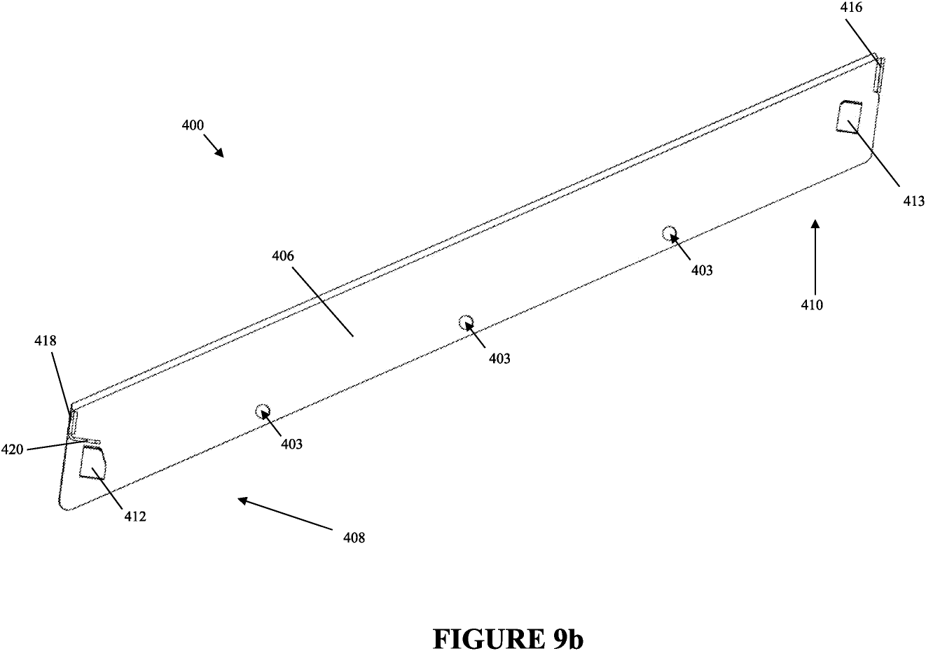

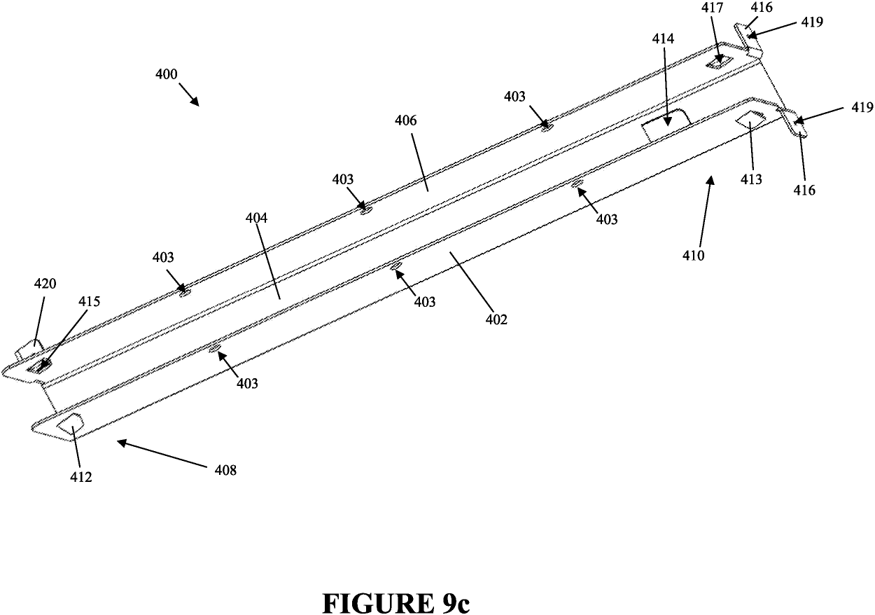

FIGS. 9a, 9b and 9c illustrate a non-limiting embodiment of a central supporting arm 400. The person skilled in the art will appreciate that the exemplary central supporting arm 400 is similar to the exemplary side supporting arm 300 except for the additional of coupling tabs 416, 418 and 420.

The central supporting arm 400 is provided with a U-shaped cross-sectional shape and comprises a first longitudinal face 402, a top face 404 and a second longitudinal face 406. It is contemplated that the lateral support arm 300 may have a different shape.

The side supporting arm 300 extends longitudinally between a first end portion 408 and a second end portion 410. The first end portion 408 is sized and shaped so as to be insertable into an opening 228b of the frame 200 and the second end portion 410 is sized and shaped so as to be insertable into an opening 272b of the frame 200 for securing the central supporting arm 400 to the frame 200. The first end portion 408 is provided with an outwardly bevelled shape and the second end portion 410 is provided with an inwardly bevelled shape.

The first end portion 408 of the side supporting arm 400 is provided with two push tabs 412 each located on a respective longitudinal face 402, 406. Each push tab 412 projects outwardly from its respective longitudinal face 402, 406 in direction of the top face 404 of the side supporting arm 400. In the illustrated embodiment, the two push tabs 412 are identical and each have the shape of a rectangle provided with a truncated corner. It should be understood that while being rigid, each push tab 412 is flexible and can be pushed towards its respective longitudinal face 402, 406. Each longitudinal face 402, 406 is provided with an aperture 415 that faces a respective push tab 412. Each aperture 415 is sized and shaped so as to allow the insertion of its respective push tab 412 therein. In the illustrated embodiment, the shape and size of the aperture 415 match those of the push tab 412. In order to secure the arm 400 to the frame 200, the first end portion 408 is inserted into the opening 228b of the frame 200 and a force is exerted on the first end portion 408, which pushes the tabs 412 into their respective apertures 415 hereby allowing a complete insertion of the first end portion 408 into the opening 228b. Once the first end portion 408 is completely inserted into the opening 228b and the push tabs 412 have crossed the opening 228b, the push tabs 412 return to their initial position, thereby removably securing the first end portion 408 to the frame 200. The first end portion 408 may be disengaged from the frame 200 by pushing the push tabs 412 towards their respective aperture 415 and pulling the supporting arm 400 away from the frame 200.

The first end portion 408 is further provided with two coupling tabs 418 and 420 which each project outwardly from the longitudinal face 406. The coupling tabs 418 and 420 are secured together so as to form an L-shaped coupling body which is located between the push tab 412 and the top face 404. The coupling tab 418 is located adjacent to the end of the top face 404 and runs along a portion of the beveled end of the longitudinal face 406. In the illustrated embodiment, the coupling tab 418 is flush with the beveled end of the longitudinal face 406. The coupling tab 420 projects from the bottom end of the coupling tab 418 in direction of the bottom end of the longitudinal face 406. In the illustrated embodiment, the coupling tab 420 is orthogonal to the coupling tab 418.

The coupling tabs 418 and 420 are each provided with a respective securing hole 422, 424 for receiving a screw therethrough in order to secure a solar panel to the first end portion 408 of the central supporting arm 400.

While the longitudinal face 402 comprises no coupling tabs such as coupling tabs 418 and 420, it should be understood that coupling tabs similar to coupling tabs 418 and 420 can be added to the longitudinal face 402.

The second end portion 410 of the side supporting arm 400 is provided with two push tabs 413 each located on a respective longitudinal face 402, 406. Each push tab 413 projects outwardly from its respective longitudinal face 402, 406 in direction of the top face 404 of the side supporting arm 400. In the illustrated embodiment, the two push tabs 413 are identical and each have a rectangular shape. It should be understood that while being rigid, each push tab 413 is flexible and can be pushed towards its respective longitudinal face 402, 406. Each longitudinal face 402, 406 is provided with an aperture (not shown) that faces a respective push tab 413. Each aperture is sized and shaped as to allow the insertion of its respective push tab 413 therein. In the illustrated embodiment, the shape and size of the aperture match those of the push tab 413. In order to secure the arm 400 to the frame 200, the second end portion 410 is inserted into an opening 272b of the frame 200 and a force is exerted on the second end portion 410, which pushes the tab 413 into their respective aperture, thereby allowing a complete insertion of the second end portion 410 into the opening 272b. Once the second end portion 410 is completely inserted into the opening 272b and the push tabs 413 have crossed the opening 272b, the push tabs 412 return to their initial position, thereby removably securing the second end portion 410 to the frame 200. The second end portion 410 may be disengaged from the frame 200 by pushing the push tabs 413 towards their respective aperture and pulling the supporting arm 400 away from the frame 200.

The second end portion 410 is further provided with two coupling tabs 416 which each project outwardly from a respective longitudinal face 402, 406. The coupling tab 416 is located adjacent to the end of the top face 404 and runs along a portion of the beveled end of the longitudinal face 402, 406. In the illustrated embodiment, the coupling tab 416 is flush with the beveled end of its respective longitudinal face 402, 406.

The coupling tabs 416 are each provided with a respective securing hole 419 for receiving a screw therethrough in order to secure two solar panels to the second end portion 410 of the central supporting arm 400.

In one embodiment, the first and second faces 402 and 406 are provided with holes 403 and the top face 404 is provided with an aperture 414 for allowing the insertion of cables therethrough for example.

In one embodiment, the holes 303 and 403 are designed so as to receive therein fasteners for holding electrical cables. In another example, a hole 303, 403 may be designed so as to receive a grounding screw therein in order to electrically connect the support structure 100 to an electrical cable connected to the ground, thereby grounding the support structure 100.

In one embodiment, the supporting arm 300, 400 is made of different plates that are secured together. For example, the different plates may be welded together. In another embodiment, the supporting arm 300, 400 is integral. In this case, the supporting arm 300, 400 may be molded. In another example, the supporting arm 300, 400 may be made of a single plate which may be folded, machined, cut out, bored, and/or the like. In one embodiment, the supporting arm 300, 400 is made of metal such as aluminum.

Referring back to FIG. 7, there is illustrated a side supporting arm 300 removably secured to the frame 200. The bottom section of the first end portion 308 of the side supporting arm 300 is inserted into the aperture 228a and the push tabs 312 abuts the frame 200. More precisely, the truncated corner of the push tab 312 each abut the supporting plate 213 of the frame 200 and the top end of the push tab 312 abuts the supporting plate 224, thereby securing the first end portion 308 of the side supporting arm 300 to the frame 200. Similarly, the bottom section of the second end portion 310 of the side supporting arm 300 is inserted into the aperture 272a and the push tabs 313 each abut the frame 200. More precisely, the left end of the push tab 313 abuts the supporting plate 215 of the frame 200 and the top end of the push tab 313 abuts the supporting plate 250, thereby securing the second end portion 310 of the side supporting arm 300 to the frame 200. As mentioned above, once the side supporting arms 300 are removably secured to the frame 200, the rigidity of the frame 200 is reinforced and the frame 200 can support the weight of at least one solar panel 500.

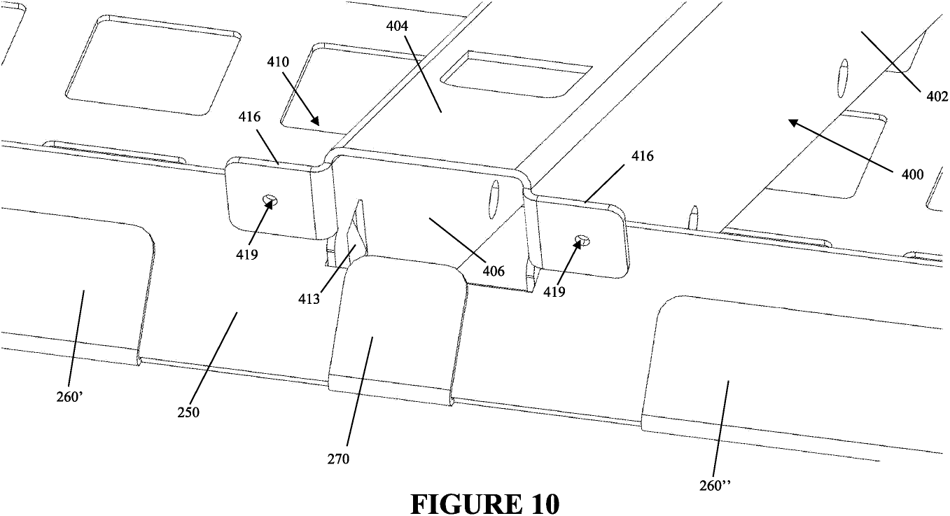

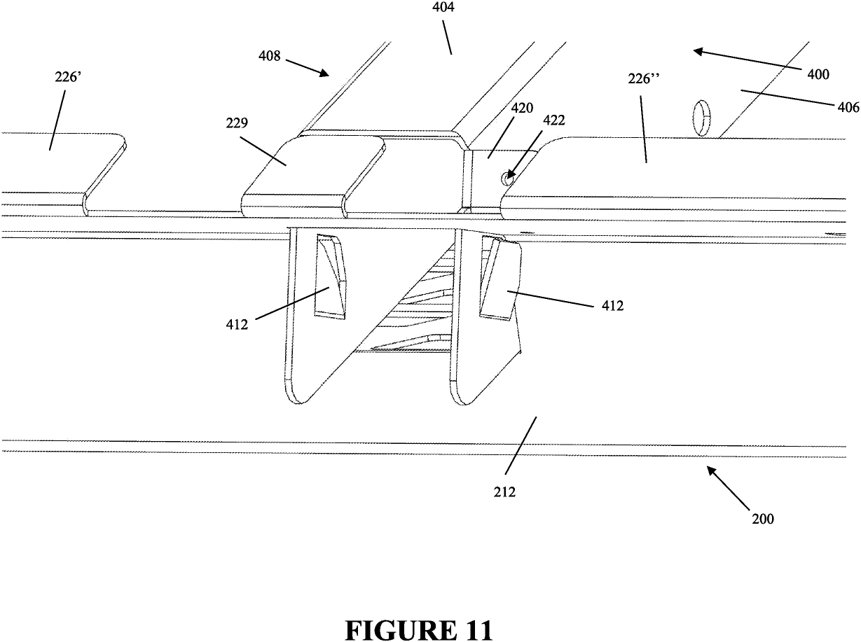

FIG. 10 illustrates the second end portion 410 of the central supporting arm 400 removably secured to the frame 200 and FIG. 11 illustrates the first end portion 408 of the central supporting arm 400 removably secured to the frame 200.

As illustrated in FIG. 11, the bottom section of the first end portion 408 of the central supporting arm 400 is inserted into the aperture 228b and the push tabs 412 abuts the frame 200. More precisely, the truncated corner of each push tab 412 abuts the supporting plate 213 of the frame 200 and the top end of the push tab 412 abuts the supporting plate 224, thereby securing the first end portion 408 of the central supporting arm 400 to the frame 200. Similarly, the bottom section of the second end portion 410 of the central supporting arm 400 is inserted into the aperture 272b and the push tabs 413 each abut the frame 200. More precisely, the left end of the push tab 413 abuts the supporting plate 215 of the frame 200 and the top end of the push tab 413 abuts the supporting plate 250, thereby securing the second end portion 410 of the central supporting arm 400 to the frame 200. As mentioned above, once the central supporting arm 400 is removably secured to the frame 200, the rigidity of the frame 200 is reinforced and the frame 200 can support the weight of at least one solar panel 500. Furthermore, the central supporting arm 400 allows for securing solar panels 500 to the frame 200 as described below.

As illustrated in FIGS. 10 and 11, once the central supporting arm 400 is removably secured tot eh frame 200, the tongues 226 and 270 faces the central supporting arm 400.

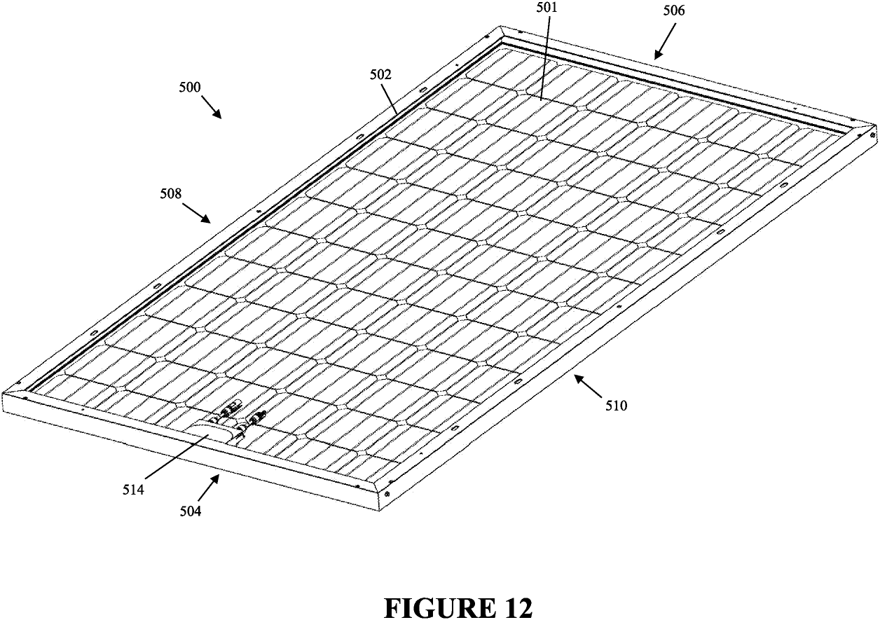

FIG. 12 illustrates a non-limiting embodiment of a solar panel 500. The solar panel 500 comprises a rectangular plate 501 having a front face on which PV cells are secured and a rear face opposite the front face. The solar panel further comprises a rectangular hollow frame 502 on which mounted the plate 501 is mounted. The frame 502 extends along the outline of the plate 501 and projects from the rear face of the plate 501.

It should be understood that the height of the portion of the frame 502 that projects from the plate 501 is chosen as a function of the characteristics of the hook-shaped bodies so that the hook-shaped bodies may engage the internal face of the frame 502 when the solar panel 500 is mounted on the frame 200.

The frame extends laterally between two opposite lateral ends 504 and 506 and longitudinally between two opposite longitudinal ends 508 and 510. In one exemplary embodiment, one of the two opposite longitudinal portions 508, 510 of the frame 502 is sized and shaped to abut on the third supporting plate 224 and to receive the first tongue 226 of the first panel supporting body 212 and the other one of the two opposite longitudinal portion 508, 510 of the frame 502 is sized and shaped to abut on the fourth supporting plate 250 and to receive the second tongue 260 of the second panel supporting body 214.

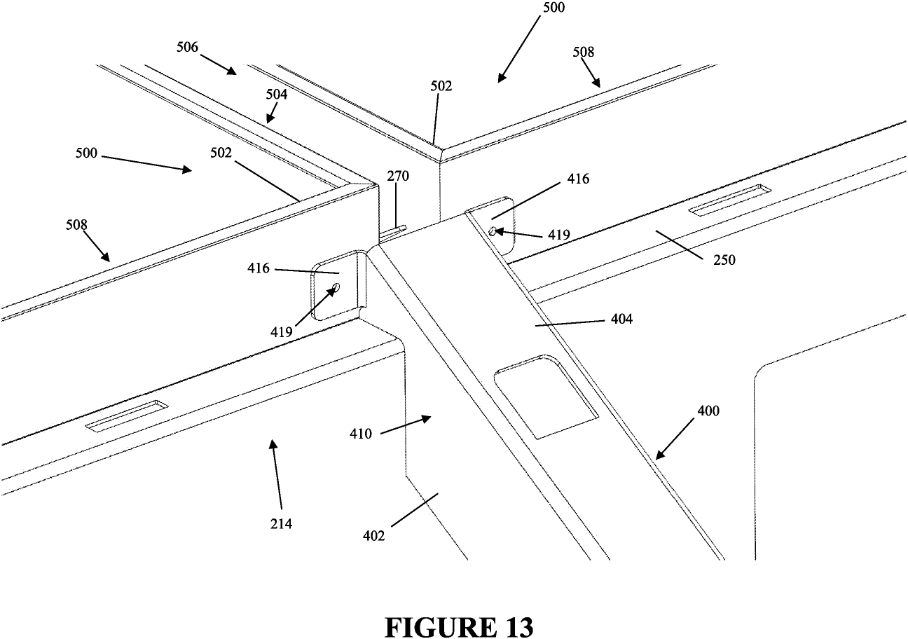

The solar panel 500 comprises a plurality of PV cells 512 which convert solar energy into an electricity. The PV cells 512 are electrically connected to a busbar (not depicted in FIG. 13), which provides the generated electricity to a junction box 514. The junction box 514 is connected to an external cable (not depicted in FIG. 13) to output the electricity generated by the solar panel 500.

FIG. 13 illustrates the support structure 100 when two first solar panels 100 are mounted to the panel supporting body 214 of the support structure 100. The first solar panels 500 are mounted on opposite sides on the central tongue 270. The end 508 of the left solar panel 500 is positioned over the tongue 260′ so that the bottom end of the frame 502 abuts the plate 250 of the panel supporting body 214, the tongue 260′ abuts the internal face of the frame 502 and the lateral end 506 of the frame 502 abuts the central tongue 270. The end 508 of the right solar panel 500 is positioned over the tongue 260″ so that the bottom end of the frame 502 abuts the plate 250 of the panel supporting body 214, the tongue 260″ abuts the internal face of the frame 502 and the lateral end 504 of the frame 502 abuts the central tongue 270. Furthermore, the end 508 of the frame 502 of each first solar panel 500 abuts a respective tab 416 of the central supporting arm 404 so that each first solar panel 500 may be fixedly secured to the central supporting arm 400 via a respective screw.

It should be understood that since the two first solar panels 500 abut opposite sides of the central tongue 270, the distance between the two first solar panels can be controlled by adequately choosing the length of the tongue 270. It should also be understood that the abutment of the internal face of the frame 502 of each first solar panel 500 against its respective tongue 260′, 260″ allows for maintaining the relative position between the first solar panels 500 and the support structure 100.

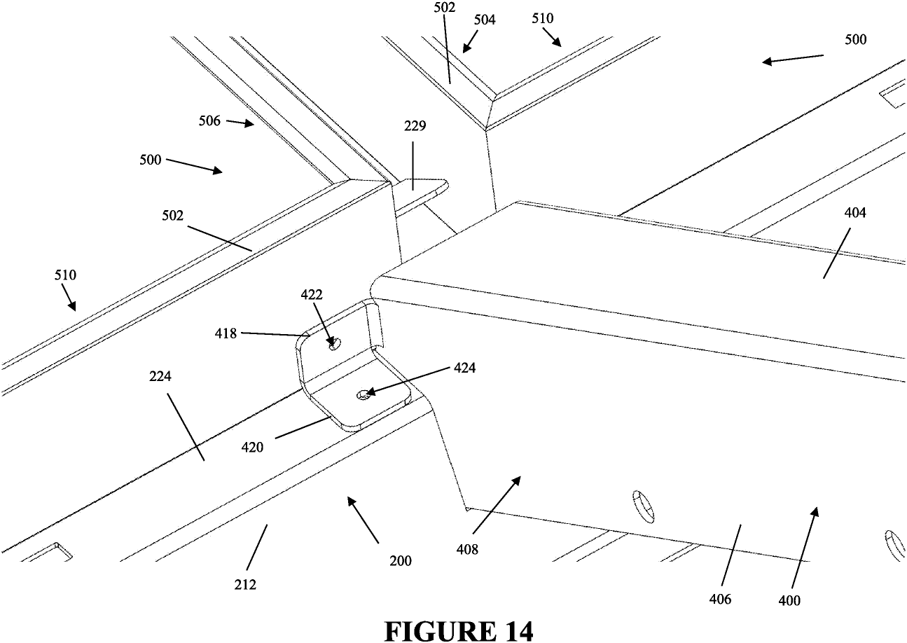

FIG. 14 illustrates the support structure 100 when two second solar panels 100 are mounted to the panel supporting body 212 of the support structure 100. The second solar panels 500 are mounted on opposite sides on the central tongue 229. The end 508 of the left solar panel 500 is positioned over the tongue 226′ so that the bottom end of the frame 502 abuts the plate 224 of the panel supporting body 212, the tongue 226′ abuts the internal face of the frame 502 and the lateral end 506 of the frame 502 abuts the central tongue 229. The end 508 of the right solar panel 500 is positioned over the tongue 226″ so that the bottom end of the frame 502 abuts the plate 224 of the panel supporting body 212, the tongue 260″ abuts the internal face of the frame 502 and the lateral end 504 of the frame 502 abuts the central tongue 229. Furthermore, the end 508 of the frame 502 of the left solar panel 500 abuts the tab 418 of the central supporting arm 404 so that the left solar panel 500 may be fixedly secured to the central supporting arm 400 via a respective screw. The tab 420 of the central supporting arm 400 abuts the supporting plate 224 so that the central supporting arm 400 be further secured to the frame 200.

It should be understood that since the two second solar panels 500 abut opposite sides of the central tongue 229, the distance between the two second solar panels 500 can be controlled by adequately choosing the length of the tongue 229. It should also be understood that the abutment of the internal face of the frame 502 of each second solar panel 500 against its respective tongue 226′, 226″ allows for maintaining the relative position between the second solar panels 500 and the support structure 100.

It should be understood that the distance between the central tongue 229 and a tongue 226′, 226″ should be large enough though accommodate the frame 502 of the solar panel 500 between the central tongue 229 and the tongue 226′, 226″. In one embodiment, the distance between the central tongue 229 and a tongue 226′, 226″ is substantially equal to or slightly greater than the thickness of the frame 502. Similarly, it should be understood that the distance between the central tongue 270 and a tongue 260′, 260″ should be large enough though accommodate the frame 502 of the solar panel 500 between the central tongue 270 and the tongue 260′, 260″. In one embodiment, the distance between the central tongue 270 and a tongue 260′, 260″ is substantially equal to or slightly greater than the thickness of the frame 502.

In order to assemble the solar panel array 10, support structures are assembled by securing two lateral supporting arms 300 and a central supporting arm 400 to a respective frame 200. Then opposite lateral faces 508 and 510 of a first solar panel 500 are mounted to four distinct support structures 100 positioned at the corner of a rectangle to form two rows of two support structure. For example, the lateral face 508 of the first solar panel is mounted to the panel supporting body 212 of two support structures 100 of a same row and the lateral face 510 of the first panel is mounted to the panel supporting body 214 of the two support structures 100 of the second row. More precisely, the left section of the lateral face 508 of the first solar panel 500 is mounted to the right section of the panel supporting body 212 of the left support structure 100 of the first row so as to abut its respective plate 224 and its tongue 226′. The right section of the lateral face 508 of the first solar panel 500 is mounted to the left section of the panel supporting body 212 of the right support structure 100 of the first row so as to abut its respective plate 224 and its tongue 226″. The left section of the lateral face 510 of the first solar panel 500 is mounted to the right section of the panel supporting body 214 of the left support structure 100 of the second row so as to abut its respective plate 250 and its tongue 260′. The right section of the lateral face 510 of the first solar panel 500 is mounted to the left section of the panel supporting body 214 of the right support structure 100 of the second row so as to abut its respective plate 250 and its tongue 260″. The distance between two adjacent support structures 100 of the each row is adjusted so that the frame 502 of the first solar panel abuts the central tongue 229, 270 of each support structure 100. The distance between facing support structures 100 of the two rows is also adjusted so that the internal face of the frame 502 of the first solar panel abuts the tongues 226′, 226″, 260′ and 260″. The assembly method is repeated to build the solar panel array 10.

It should be understood that a same solar panel 500 is mounted to four different support structure 100 and a single support structure 100 can support partially up to four distinct solar panels 500.

In one embodiment, the present support structure 100 allows for an easy and quick installation of a solar panel according to a desired orientation fort the solar panel, and also an easy and quick installation of an array of solar panels 500.

In one embodiment, the support structure 100 and the frame 502 of the solar panels 500 is made of an electrically conductive material such as metal. Int this case, the solar panels 500 of the array 10 are all electrically connected via the support structures 100 and the screws securing the solar panels to the support structures 100. The array 10 of solar panels 500 can therefore be grounded by connected only a single solar panel 500 or a single support structure 100 to the ground. No running grounding cables are therefore required throughout the structure.

It should be understood that the illustrated support structure 100 is exemplary only and modifications to the support structure 100 can be made. For example, the number, position, size and/or shape of the tabs 416, 418 and/or 420 may be vary. The number, position, size and/or shape of the supporting arms 300 and/or 400 may vary. For example, the support structure 100 may comprise no supporting arm 300, 400. In another example, the lateral supporting arms 300 may be omitted.

It will be appreciated that the characteristics of the support structure 100 may be adjusted to obtain a desired orientation for the solar panels 500. For example, the characteristics of the support structure 100 may be chosen so as to obtain an orientation of 5, 10, 15, or 20 degrees for the solar panels 500. It should be understood that the orientation of the solar panels 500 depends at least on the widths of the supporting plates 215 and 224 and the angles between the supporting plates 215 and 224 and the base plate 202. Therefore, the widths of the supporting plates 215 and 224 and the angles between the supporting plates 215 and 224 and the base plate 202 are chosen at least based on the desired orientation for the solar panels 500.

In one or more embodiments, the support structure 100 is made from aluminum.

In one exemplary embodiment, the plate assembly 200 of the support structure 100 comprises a plurality of holes 207 which diminish the weight of the solar panel assembly.

It will be appreciated that the support structure 100 may be used as a ballast tray and wind deflector.

In accordance with one or more embodiments of the present technology, there is provided a support structure for solar panels which is easy to manufacture and/or assemble and/or does not require specialized tools or skills for installation. The support structure of the present technology enables mounting and connecting solar panels together, and may be used as a ballast tray and/or a wind deflector. The support structure may accommodate different solar panel structures and may be manufactured to accommodate different orientations for the solar panels relative to the surface on which they are installed. Self-tapping grounding screws may be used with the support structure for grounding needs.

The embodiments of the invention described above are intended to be exemplary only. The scope of the invention is therefore intended to be limited solely by the scope of the appended claims.

1. A support structure for solar panels comprising:
a frame comprising:
a base plate for abutment on a receiving surface, the base plate extending laterally between a first lateral end and a second lateral end;
a first supporting plate projecting from the base plate at the first lateral end thereof;
a second supporting plate projecting from the base plate at the second lateral end thereof;
a first hook-shaped body secured to the first supporting plate for supporting at least one first solar panel; and
a second hook-shaped body secured to the second supporting plate for supporting at least one second solar panel.

2. The support structure of claim 1, wherein the first hook-shaped body comprises a third supporting plate projecting outwardly from the first supporting plate and at least one tongue projecting inwardly from the third supporting plate for holding the at least one first solar panel.

3. The support structure of claim 2, wherein the at least one first solar panels comprises two first solar panels and the at least one tongue comprises a first tongue extending along a first given section of a length of the third supporting plate for holding a given one of the two first solar panels and a second tongue extending along a second given section of the length of the third supporting plate for holding another of the two first solar panels, the first and second tongue being longitudinally spaced apart.

4. The support structure of claim 3, wherein the third supporting plate extends longitudinally between a first longitudinal end and a second longitudinal end, the first tongue being adjacent the first longitudinal end and the second tongue being adjacent the second longitudinal end.

5. The support structure of claim 3, wherein the at least one tongue further comprises a spacer tongue projecting inwardly from the third supporting plate and being positioned between the first and second tongues, the spacer tongue being longitudinally spaced apart from the first and second tongues by a given distance.

6. The support structure of claim 5, wherein the given distance is chosen based on a thickness of a frame of the first solar panels.

7. The support structure of claim 6, wherein the given distance is equal to the thickness of the frame.

8. The support structure of claim 1, wherein the second hook-shaped body comprises a third supporting plate projecting outwardly from the second supporting plate and at least one tongue projecting inwardly from the third supporting plate for holding the at least one first solar panel.

9. The support structure of claim 8, wherein the at least one second solar panels comprises two first solar panels and the at least one tongue comprises a first tongue extending along a first given section of a length of the third supporting plate for holding a given one of the two second solar panels and a second tongue extending along a second given section of the length of the third supporting plate for holding another of the two second solar panels, the first and second tongue being longitudinally spaced apart.

10. The support structure of claim 9, wherein the third supporting plate extends longitudinally between a first longitudinal end and a second longitudinal end, the first tongue being adjacent the first longitudinal end and the second tongue being adjacent the second longitudinal end.

11. The support structure of claim 9, wherein the at least one tongue further comprises a spacer tongue projecting inwardly from the third supporting plate and being positioned between the first and second tongues, the spacer tongue being longitudinally spaced apart from the first and second tongues by a given distance.

12. The support structure of claim 11, wherein the given distance is chosen based on a thickness of a frame of the first solar panels.

13. The support structure of claim 12, wherein the given distance is equal to the thickness of the frame.

14. The support structure of claim 1, wherein the first hook-shaped body comprises a third supporting plate projecting outwardly from the first supporting plate and at least one first tongue projecting inwardly from the third supporting plate for holding the at least one first solar panel, and the second hook-shaped body comprises a fourth supporting plate projecting outwardly from the second supporting plate and at least one second tongue projecting inwardly from the fourth supporting plate for holding the at least one second solar panel.

15. The support structure of claim 14, further comprising a central arm extending between a first arm portion and a second arm portion, the frame being further provided with a first aperture extending partially in the first supporting plate and partially in the third supporting plate and a second aperture extending partially in the second supporting plate and partially in the fourth supporting plate, the first aperture for receiving therein the first arm portion and the second aperture for receiving therein the second arm portion.

16. The support structure of claim 15, wherein the first arm portion is provided with at least one first push tab projecting from a lateral face thereof and the second arm portion is provided with at least one second push tab projecting from a lateral face thereof for removably securing the central arm to the frame.

17. The support structure of claim 15, wherein the first arm portion is provided with at least one first connection tab projecting from a lateral face thereof for securing the first arm portion to at least one the at least one first solar panel, and the second arm portion is provided with at least one second connection tab projecting from a lateral face thereof for securing the second arm portion to at least one the at least one second solar panel.

18. The support structure of claim 14, wherein the at least one first tongue comprises two first lateral tongues and a first central tongue and the at least one second tongue comprises two second lateral tongues and a second central tongue, the first central tongue being spaced apart from the two first lateral tongues and positioned between the two first lateral tongues, the second central tongue being spaced apart from the two second lateral tongues and positioned between the two second lateral tongues, the first central tongue facing the first aperture and the second central tongue facing the second aperture.

19. The support structure of claim 15, further comprising at least one lateral arm extending between a first arm section and a second arm section, the frame being further provided with at least one first lateral aperture extending partially in the first supporting plate and partially in the third supporting plate, and at least one second lateral aperture extending partially in the second supporting plate and partially in the fourth supporting plate, the first arm section being insertable into the at least one first lateral apertures and the second arm section being insertable into the at least one second lateral aperture for removably securing the at least one lateral arm to the frame.

20. The support structure of claim 19, wherein the first arm section is provided with at least one first push tab projecting from a lateral face thereof and the second arm section is provided with at least one second push tab projecting from a lateral face thereof for removably securing the central arm to the frame.

21-24. (canceled)
